(19) United States
(12) Patent Application Publication
(10) Pub. No.: US 2008/0148342 A1
(43) Pub. Date: Jun. 19, 2008

(54) MANAGEMENT OF APPLICATION SPECIFIC DATA TRAFFIC

(75) Inventors: Sanjay Aiyagari, Sunnyvale, CA (US); Sandeep Kumar, Cupertino, CA (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: CISCO TECHNOLOGY, INC., San Jose, CA (US)

(21) Appl. No.: 11/609,943

(22) Filed: Dec. 13, 2006

(51) Int. Cl. G06F 15/173; H04L 9/00

(52) U.S. Cl. 726/1; 709/238

(57) ABSTRACT

A system and/or method that enables hosting entities, such as application service providers (ASPs) to identify target sources (e.g. domains) for data traffic is provided. Additionally, data traffic can be segmented as a function of available sources and subsequently directed to specific hosting environments thereby affording the ASP ability to efficiently scale resources. Further, the segmented data traffic and corresponding environments enable the ASP to more effectively secure client resources and data by applying back-end filters and other suitable security mechanisms that correspond with a traffic-specific security policy that can be tagged to the traffic for use throughout distribution.

### TECHNICAL FIELD

The subject disclosure relates generally to application service providers (ASPS) and more particularly to segmenting traffic and directing traffic to task specific environments such that ASPs can scale their resources more efficiently, while still providing customized security policies for their clients.

### BACKGROUND

A commercial service provider, more commonly known as an application service provider (ASP) refers to an organization that hosts software applications on its own servers within its own facilities on behalf of individual clients. These clients span businesses, government organizations, non-profits, and membership organizations. The software applications are made available to customers and/or subscribers through access via the Internet or a private line connection. With the advent of the Web browser as the universal client interface, the ASP market continues to grow.

Effectively, an ASP is a business that provides computer-based services to customers over a network. Applications and software available via an ASP model are also often referred to as ‘on-demand’ software. Other examples of this ASP model can be experienced through an on-line storefront using a standard protocol such as HTTP. These virtual stores accessible through the Internet provide product information, ordering capability and provision for secure transfer of payment.

Some believe that the need for ASPs evolved from the increasing costs of specialized software. In other words, these increasing costs made specialized software economically unfeasible for most small to medium sized businesses. As well, the ever-evolving complexities of software have led to huge costs in distributing the software to end-users. Through ASPs, the complexities and costs of such specialized software can be dramatically reduced. In addition, the costs of upgrading software have been eliminated from the end-user by placing the burden on the ASP to maintain up-to-date services, overall technical support as well as physical and electronic security.

Today, due to the popularity and ease of Internet connectivity, ASPs provide content and security services to multiple clients regardless of size and/or location. While the ASP would like to leverage their combined processing power in their data center to scale to the combined needs of their clients, this potential is rarely realized, as these clients have individual and valid concerns that they do not want security holes in other companies' applications which may adversely affect their network and overall service to their customers.

Therefore, rather than enabling the ASP to supply shared hosting services, most often clients request that ASPs ‘wall off’ in their networks, each with their own servers. In other words, because shared hosting (e.g. hosting multiple clients on the same physical servers) sometimes exposes clients to security risks and concerns, dedicated hosting (e.g., providing individual servers and/or clusters for each client) is sometimes requested. While this dedicated arrangement may address some of the client's security concerns, no economies of scale can be achieved by the ASP through the sharing of back-end resources, such as databases and large-scale web farms.

Sometimes ASPs can apply security services to traffic in an attempt to increase security for clients. However, when providing these security services via policy enforcement points, more often than not either the message is subjected to too many policy checks or too little. Thus, it is rarely the case that the right kinds of context sensitive application security policies are applied to a message(s) based on their usage model and network sandboxing needs.

### BRIEF DESCRIPTION OF THE DRAWINGS

FIG. 1 illustrates a block diagram of an example traffic management component that facilitates regulating delivery of data traffic in accordance with an aspect of the specification.

FIG. 2 illustrates a block diagram of an example traffic segmenting component that facilitates separating traffic via analysis of content and/or type in accordance with an aspect of the innovation.

FIG. 3 illustrates a block diagram of an example traffic routing component that facilitates tagging and delivery of traffic in accordance with an aspect of the innovation.

FIG. 4 illustrates an architectural block diagram of a system that facilitates receipt, analysis, segmentation, and delivery of traffic to a specific domain(s) in accordance with an aspect of the innovation.

FIG. 5 illustrates an example architectural block diagram of a system that facilitates distributing traffic to specific domains in accordance with an Internet storefront scenario.

FIG. 6 illustrates an example architectural block diagram of a system that employs a virtual front-end to segment and tag traffic with a policy and a virtual back-end that applies the policy to manage security accesses of shared data.

FIG. 7 illustrates an example flow diagram of procedures of segmenting and distributing packets in accordance with service specific domains.

FIG. 8 illustrates an example flow diagram of procedures of applying security policies with respect to specific domains in accordance with an aspect of the innovation.

FIG. 9 illustrates a block diagram of a computer operable to execute the disclosed architecture.

FIG. 10 illustrates a schematic block diagram of an exemplary computing environment in accordance with the subject innovation.

### DESCRIPTION

### Overview

The following presents a simplified overview of the claimed subject matter in order to provide a basic understanding of some embodiments described herein. This is not an extensive overview of the claimed subject matter. It is intended to neither identify key or critical elements of the claimed subject matter nor to delineate the scope of that subject matter. Its sole purpose is to present some concepts of the claimed subject matter in a simplified form as a prelude to the more detailed description of example embodiments that is presented later.

The claimed subject matter, in one aspect thereof, relates to a system that enables hosting entities, for example application service providers (ASPs) to virtualize security services by using a single front-end device to identify and apply security policy sets. The application of a policy within a policy set can be employed to tag the traffic with metadata associated to a specific security domain. This metadata can be used via a back-end device to aggregate traffic within certain domains for better and more efficient use of resources.

The following description and the annexed drawings set forth in detail certain illustrative embodiments of the claimed subject matter. These embodiments may be indicative, however, of but a few of the various ways in which the principles of the claimed subject matter may be employed and the claimed subject matter is intended to include many and/or all such embodiments and their equivalents. Other advantages and novel features of the claimed subject matter will become apparent from the following description of example embodiments when considered in conjunction with the drawings.

### Description of Example Embodiments

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The subject specification describes systems and methods that enable ASPs as well as other hosting entities to identify target sources for data traffic and accordingly, to segment the data traffic as a function of available sources. Subsequently, this segmented data traffic can be directed to specific hosting environments thereby affording the ASP ability to efficiently scale resources. Moreover, the segmented data traffic and corresponding environments enables the ASP to more effectively secure client resources and data by applying back-end filters and other suitable security mechanisms.

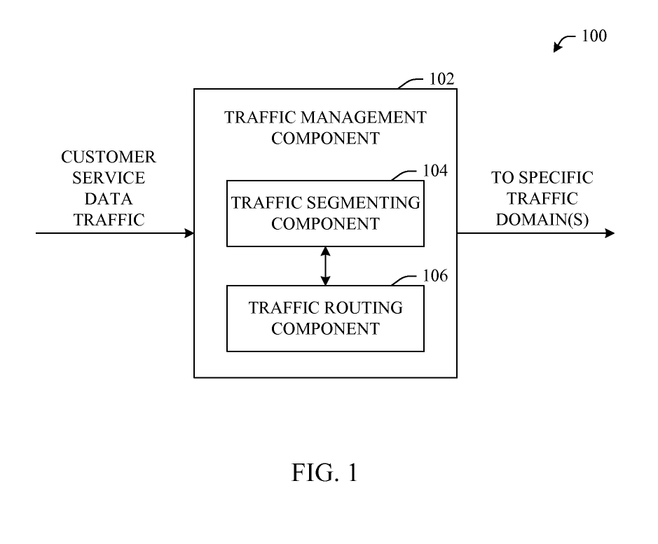

Referring initially to the drawings, FIG. 1 illustrates a system 100 that facilitates segmenting and routing traffic to specific traffic domains in accordance with an aspect of the innovation. Generally, the system 100 can include a traffic management component 102 having a traffic segmenting component 104 and a traffic routing component 106 therein. In operation, the traffic segmenting component 104 can automatically determine a type of traffic that corresponds to received traffic. Accordingly, the traffic routing component 106 can be employed to route the traffic to a predefined domain(s) as a function of the traffic type. As described supra, application service providers (ASPs) can direct this data traffic to task specific environments such that the ASPs can scale their resources more efficiently, while providing customized security policies for their client.

While the example embodiments described herein are directed to an Internet storefront, it is to be understood that the novel functionality of leveraging segmented traffic to enhance scalability and/or security can be applied to most any hosting environment without departing from the spirit and/or scope of the specification and claims appended hereto. As such, it is to be understood that the additional example uses (e.g., applications, websites) of the disclosed functionality are to be included within the scope of this disclosure and claims appended hereto.

Essentially, this disclosure is directed to ASPs however, it is to be understood that the features, functions and benefits described herein can be used beyond ASPs. The example embodiments described herein are directed to the service provider (e.g., ASP), company and consumer.

As described supra, a company need not directly actually host equipment. Rather, their equipment can alternatively be hosted by another hoster (e.g., ASP). Today, primarily ASPs provide two basic services, shared hosting and dedicated hosting. Shared hosting refers to the arrangement or architecture where the ASP puts multiple clients' sites and/or applications on the same machine or cluster of machines. Thus, all of the sites and/or applications run in parallel sharing resources (e.g., storage space, bandwidth, processing power).

On the other hand, in a dedicated hosting arrangement, the ASP dedicates machines to specific clients. In this arrangement, each client has a full access to resources within its own domain. However, while dedicated hosting affords scalability, because all traffic is processed through the same machine(s), opportunity exists for malicious attacks upon the data as all data resides within the same environment.

Most often, smaller or newer clients tend to subscribe to shared hosting arrangements. One drawback to a shared arrangement is that all of the clients associated with a cluster of machines have to share the processing power and bandwidth of those machines. This can become troublesome as clients grow and draw more and more traffic. As a result, performance of all clients that are hosted within the shared arrangement are impacted in terms of bandwidth.

Additionally, as stated above, another drawback of this conventional shared arrangement is the lack of control over security. In other words, if there is a security hole in one client's website, the security of all of the websites hosted by the cluster may also be in jeopardy. For instance, if a hacker is able to gain access to the environment via a security hole in one client's website, this access can be propagated to enable access to other websites within the same shared hosting arrangement.

Larger and more established clients tend to subscribe to dedicated hosting arrangements. These dedicated hosting arrangements enable a customer to have control over bandwidth as well as limited security issues related to their particular resources. The subject specification describes an architecture and technique that leverage the efficiencies of shared hosting together with the scalability and security benefits of the dedicated hosting.

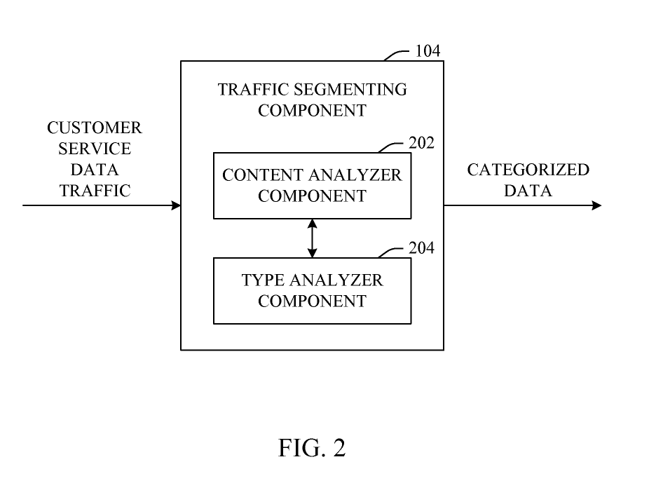

Referring now to FIG. 2, a block diagram of an example traffic segmenting component 104 is shown to include a content analyzer component 202 and a type analyzer component 204. Although, the example traffic segmenting component 104 is shown to include both a content analyzer and a type analyzer (e.g., 202, 204), it is to be understood that each of these components can be employed individually to enable segmenting traffic in accordance with a target domain (e.g., browsing, ordering, administration).

As discussed above, one benefit of shared hosting is that the ASP can employ a single large machine or web farm in order to host multiple clients. Thus, when a resource is added, the resource can benefit all clients hosted within the shared arrangement. This configuration can be scaled up globally for the aggregate of what is needed. In other words, as traffic increases, the complete cluster can be upgraded to handle the increase in traffic rather than addressing each client separately by increasing resources. However, this traditional architecture creates security concerns as all traffic enters the environment via the same channel or interface.

As clients grow they tend to gravitate to dedicated hosting for bandwidth issues (e.g. traffic) as well as control over security. For instance, if a hacker is able to access a site within a shared arrangement, there is concern that the other sites within the configuration can also be vulnerable from a security standpoint. However, although a single client can have control over security in a dedicated arrangement, security concerns continue to exist. These security concerns continue to exist primarily because, as described above with reference to a shared arrangement, all traffic enters the domain through the same channel and/or interface.

Contrary to conventional shared or dedicated architectures, the subject specification discloses mechanisms to split up or segment the application(s) and/or service(s) based upon the type of traffic. For example, in an Internet storefront scenario, traffic specific domains can be defined and traffic can be directed to browsing a catalog, placing an order, and maintaining administrative issues (e.g., processing payment using confidential credit card or bank account information). It will be appreciated that each type of traffic is very different from the next in that they have different needs from a processing and security standpoint.

Here, a content analyzer component and/or a type analyzer component 204 can be employed to inspect the received packets thereby determining which target domain would be appropriate to receive the data. As will be better understood upon a review of the figures that follow, scalability and security can be addressed by defining these target domains and diverting traffic accordingly.

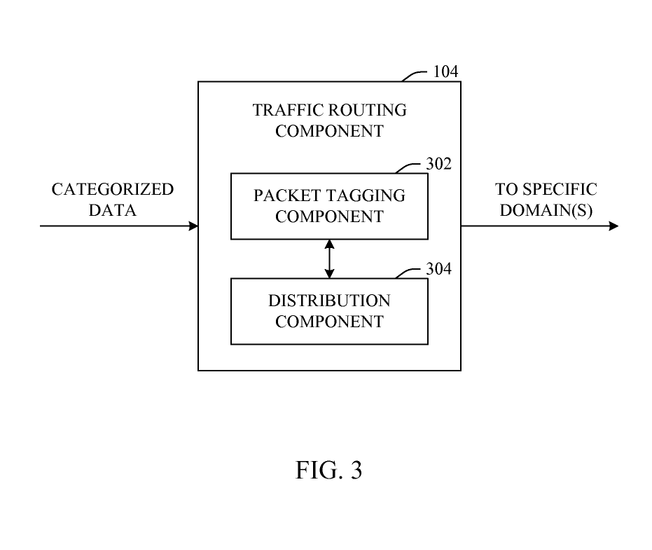

Referring now to FIG. 3, a block diagram of an example traffic routing component 106 is shown. In particular, the traffic routing component 106 can include a packet tagging component 302 and a distribution component 304. In operation, once the traffic is segmented (e.g., via the traffic segmenting component 104 of FIG. 1), the packet tagging component 302 can be employed to apply identifying indicia to the packets such that the distribution component 304 can divert traffic to traffic specific domains. It is to be appreciated that the subject innovation can maintain a security tag with the traffic as it passes through the network. As well, to enhance performance, aspects can maintain the tag(s) in a form that is understandable without deep packet inspection.

While the example traffic routing component 106 is illustrated to include a packet tagging component 302, it is to be understood and appreciated that alternative aspects can employ pre-tagged or pre-identified traffic such that the distribution component 304 can allocate traffic to appropriate domains in accordance with traffic type. In other words, it is to be understood that traffic can be pre-tagged with identifying indicia or dynamically tagged such that the distribution component 304 can effectively redirect traffic to appropriate domains.

The following example is included to add perspective to this disclosure. More particularly, the storefront example is included to describe the value of the disclosed systems and methods of segmenting and distributing traffic to specific domains for processing as a function of traffic content and/or type. This example is not intended to limit the innovation in any way.

Continuing with the Internet storefront example, traffic can be segmented into at least three overall categories, browsing, ordering and administration. With respect to browsing the catalog, a large amount of processing power would be necessary in the browsing domain as there are most often a large number of people accessing the information. As well, within this browsing domain, there is often exchange of information and data (e.g., image files, product data) that require a large amount of processing power and resources. Similarly, it will be understood that catalog browsers would not have a need to upload or modify data within the domain. Rather, the actions performed in browsing a catalog are merely limited to retrieval of information related to products, pricing, etc.

With regard to placing an order, most often, there are usually not as many hits within the order taking domain as there are within a browsing domain. As such, the server or cluster of servers that hosts the order management processes can usually be smaller than that needed for the browsing domain. For instance, when a customer places an order, it is usually for a single item or a select group of items which only requires limited modification to the database.

Continuing with the Internet storefront scenario, as system administrators are limited in number, usually one, there is very little need for scalability. Thus, this administrative environment can usually be limited to a single server since there is not much traffic within this domain.

Essentially, this division of traffic domains enables a provider (or hosting entity, ASP) to scale machines and processing power in direct relation to specified traffic type. For instance, as browsing traffic increases, the browsing environment can be scaled up independent of order taking and/or administration. The flexibility provides for efficient use of resources within specific domain environments.

While scalability is a direct benefit of categorizing domains, both the hosting entity as well as their clients benefit with regard to security. Because domains are categorized, security mechanisms can be employed with regard to each specific domain without affecting the other of the domains. As well, because domains are categorized, a global security policy can be applied to all traffic of a particular type without affecting traffic of other types.

From a security dimension, browsing traffic should not be allowed to change anything within the database. Similarly, ordering traffic should only be allowed to read/write to update quantities associated to a specific order while administration should be able to change anything. Thus, because domains can be separated, in accordance with the example Internet storefront, there can be three disparate scalability domains that map very closely to security domains.

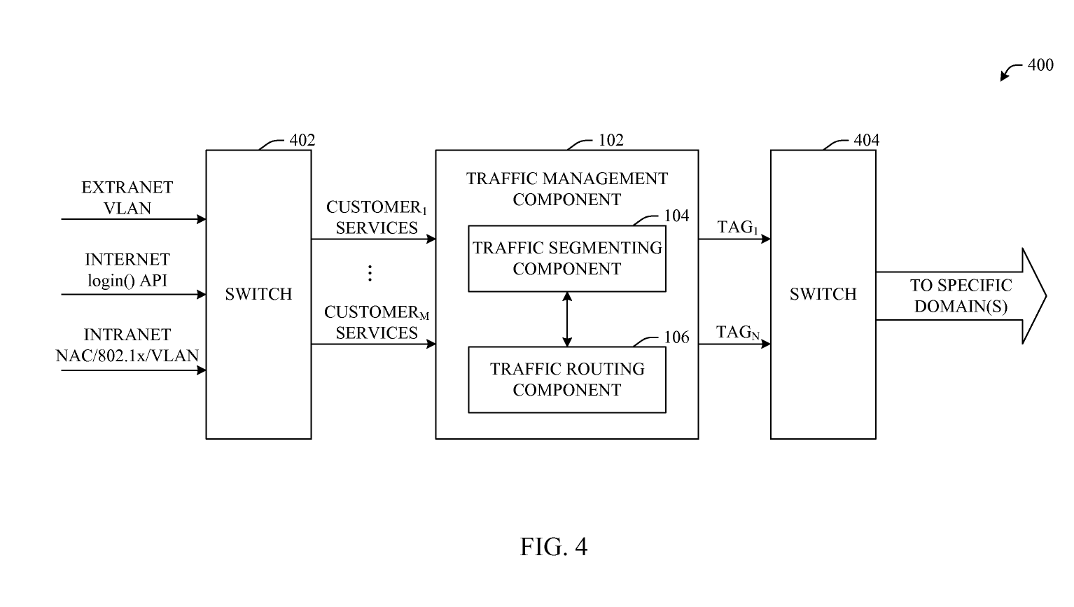

Turning now to FIG. 4, a system 400 that illustrates the aforementioned functionality in accordance with an Internet storefront is shown. Generally, system 400 includes a front-end switch 402 that receives traffic from a number of disparate authentication domains, for example, an internal VLAN, over the Internet with a specific login, or authentication protocols such as Network Admission Control (NAC) or IEEE 802.1x. Although specific protocols are shown, it is to be understood that the system 400 can be employed with other protocols without departing from the spirit and/or scope of this disclosure and claims appended hereto.

Once the traffic is received by switch 402, the traffic can be associated to 1 to M customer services, where M is an integer. As illustrated in FIG. 4, the customer services traffic can be input to the traffic management component 102 and thereafter marked (e.g., tagged) in accordance with a specific type of traffic. More particularly, the traffic segmenting component 104 can be used to identify a target domain for each of the customer traffic inputs. As discussed with reference to FIG. 2 supra, the content, type and authentication domain of the inputs can be analyzed in order to segment incoming traffic.

Once the traffic is analyzed and the target domain(s) is determined, the traffic routing component 106 can employ identifying indicia (e.g. tags 1 to N, where N is an integer) applied to each of the inputs in order to direct the traffic to particular specific domains via switch 404. Continuing with the example above, the tagged traffic can be directed to the appropriate domain, for example, browsing domain, ordering domain, or administrative domain.

Essential, in accordance with the innovation, traffic can be separated with respect to the particular type of traffic (e.g., browsing, ordering, administration) and forwarded to the specific domain for processing. Thus, as described in greater detail above, the ASP (and its clients) can benefit both from the scalability and the security space. It will be appreciated that the identifying indicia can effectuate the traffic to be forwarded to an appropriate pre-defined domain while defining an applicable security policy.

In accordance with the Internet storefront above, if the traffic is browsing and identified and tagged as such, this traffic can be automatically directed to a shared environment tailored for browsing traffic. This environment can have massive scalability and support a huge number of hits. From a security standpoint, unlike a conventional shared hosting arrangement, because each environment is specifically set up to handle specific traffic, filters and other back-end security mechanisms can be applied to the environment. As such, modification to data within a shared database can be controlled in each specified environment. Similarly, security can be controlled with regard to ordering and administrative traffic within specific domain environments.

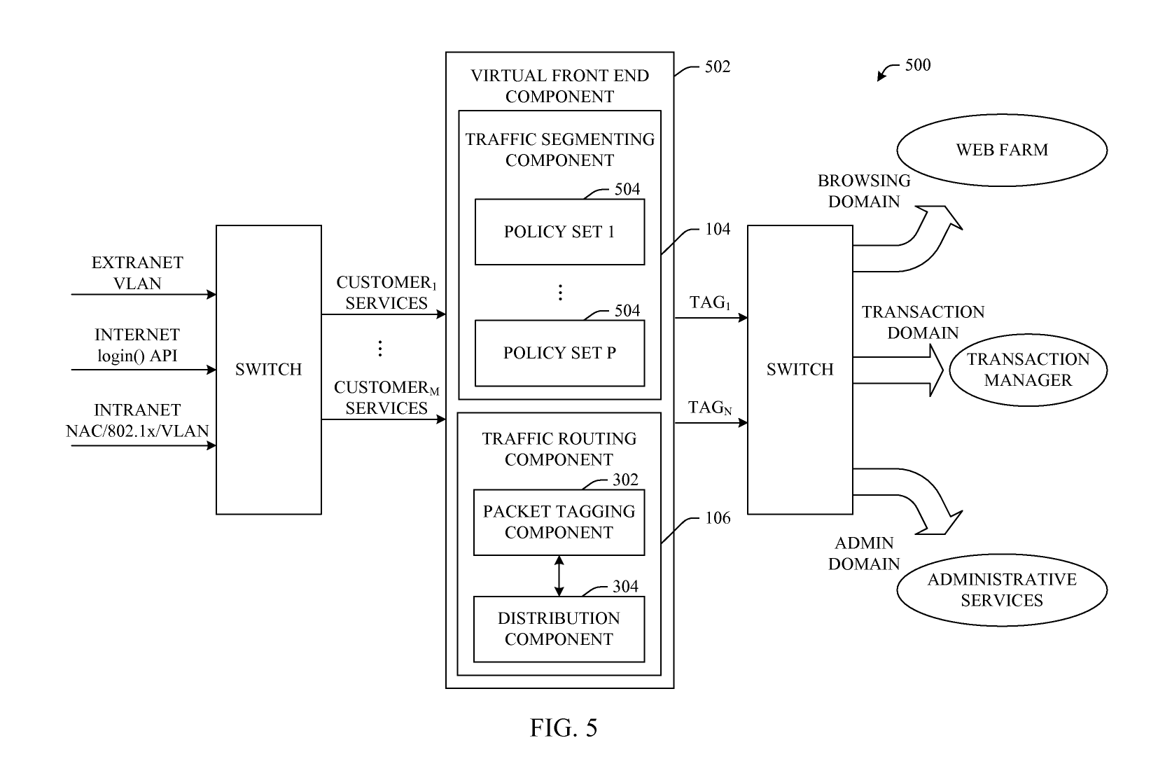

Referring now to FIG. 5, a system 500 that facilitates directing traffic to domain specific environments in accordance with the aforementioned Internet storefront example. It will be appreciated that, as far as a conventional router is concerned, all traffic is merely being directed to the ASP. Even though the client may intend for their traffic to be transmitted to a specific company, the packets are really going to the ASP and distributed to the companies thereafter. In accordance with the virtual front-end component 502, it can be possible to identify which traffic is for browsing, which traffic is for ordering and which traffic is for administration. Thus, the traffic segmenting component 104 and the traffic routing component 106 can be employed to leverage benefits both in the scalability and security space by automatically directing traffic to an appropriate domain.

As illustrated in FIG. 5, the traffic segmenting component 104 can include 1 to P policy sets, where P is an integer. It is to be understood that 1 to P policy sets can be referred to individually or collectively as policy sets 504. In operation, the policy set 504 can be applied to determine and enable if the traffic is browsing traffic and identified as such, then that traffic should be directed by the ASP to a shared environment with massive scalability that supports a huge number of browsing hits.

From a security standpoint, rather than including the ordering and administrative functionality, policy set 504 can be applied to limit browsing traffic to merely query information and specifically prohibit any modification to the shared database. Thus, because specific interfaces are employed together with policy set(s) 504, the security issues of a conventional shared hosting environment can be avoided. By way of example, the issue of someone hacking in and stealing orders, credit card information or the like can be eliminated because there is no access from the browsing interface. In other words, the back-end of this browsing environment can be limited to ‘read-only’ with respect to the database.

Similarly, looking at the ordering space, a policy set 504 can be applied and thus, this traffic can be directed to a dedicated hosting environment such that access can be limited to orders. Here, it will be appreciated that the number of hits will be limited only to those ordering and wanting to pay for products ordered. Further, it will be appreciated that ordering traffic most often has a much lower bandwidth volume than browsing traffic as the graphics are not usually as necessary. In all, the policy set 504 can be employed to configure or define the security preferences and/or rights based upon a traffic type.

In conventional environments, because different types of traffic share domains, much of the data is vulnerable to malicious attacks and unintended access. It will be appreciated that a somewhat common way to hack a website is for a malicious agent to employ an order form to trick the system. By way of particular example, an attacker can insert a SQL command into an order form rather than the expected data, for example, customer name. Because in conventional systems, everything is running on the same cluster of machines, the back-end does not know that this input is not administrative traffic and therefore executes the SQL command. Thus, security is easily breached and data can be exposed, modified or even deleted.

In contrast, as shown in FIG. 5, the subject system 500 enables traffic to be identified, segmented and directed to domain specific environments whereby the back-end can control the security specific to the traffic type. For example, in the instance of ordering traffic, the back-end can limit access to only those data items associated with those being purchased. The policy sets 504 can be employed to both identify and segment traffic as well as to define security mechanisms to be applied on the back-end but before the database.

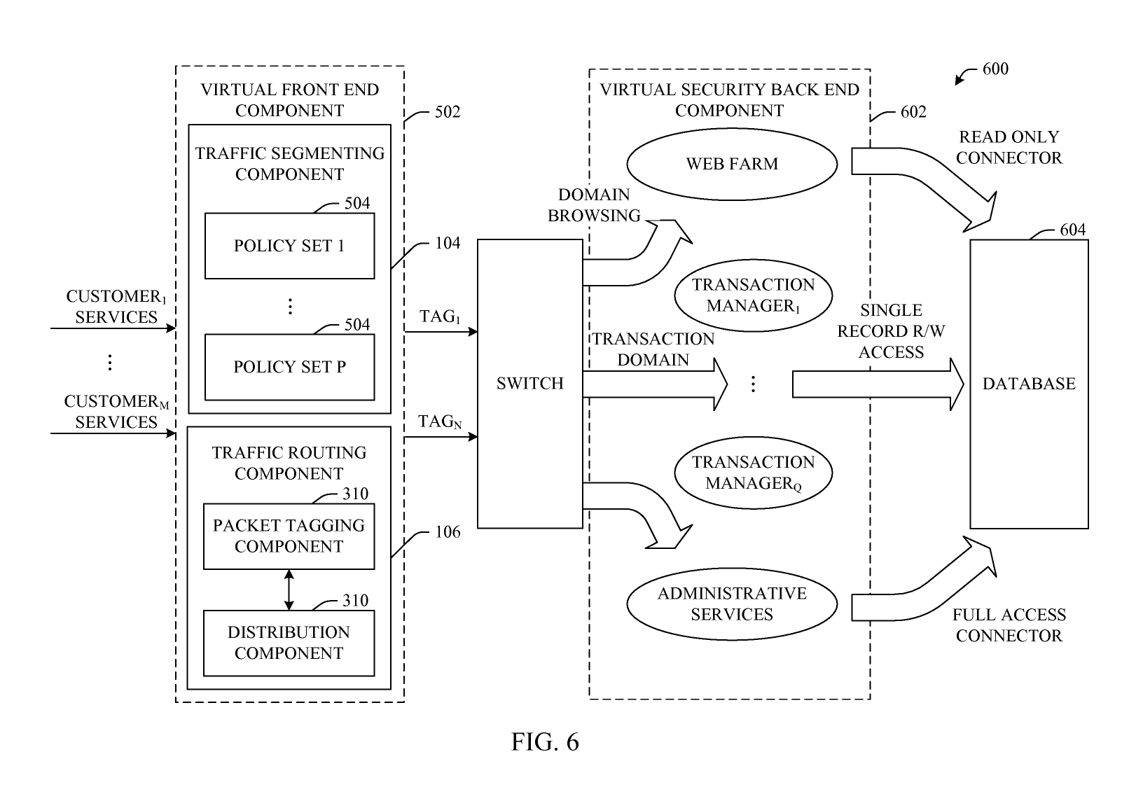

Referring now to FIG. 6, an alternate architectural diagram of a system 600 that facilitates segmenting traffic and directing the traffic to specific domains is shown. As illustrated, system 600 can include a virtual front-end 502 and a virtual back-end 602 which effectuates limiting access rights to a shared database based upon traffic type and applicable policy set 504. Because traffic is segmented and directed to specific environments, it can be understood that the links between each specific environment (e.g., browsing, ordering, administration) would be limited to traffic that matches each specific environment. Thus, each type of traffic can be secured appropriately or as desired.

As shown, database connectors can be employed between the virtual back-end 602 and the shared database 604. In operation, a database connector can be configured such that the traffic can employ read-only, read/write, or write operations as appropriate. For example, browsing traffic can be prohibited from writing, ordering traffic can have very limited read/write access in accordance with a particular order and the administrative traffic can have all-access to data in the database.

As described above, because traffic is segmented ahead of time (e.g., via traffic segmenting component 104), it is not necessary to enable an administrator to access the database 604 via the ordering system. Rather, the administrator will have a dedicated access path through a particular administration interface connector. Thus, security can be managed through each appropriate interface connector.

Because security can be controlled at the connector, the aforementioned scenario of a malicious attacker pretending to place an order by typing a SQL command will not be possible as administrative traffic will not access the database through the ordering interface connector. In other words, because traffic is segmented, filters can be put into place via the connectors on the back-end of each of the specific environments (e.g., browsing, ordering, administrative).

In conventional systems, filters cannot be used as they would inherently filter out commands that may be legitimate. For example, if a filter was put into place to filter SQL commands, these filters would filter SQL commands for all types of traffic including administrative, where SQL commands may be necessary. Similarly, it would not be possible to have global read-only access to a database as people need to be able to place orders and to update quantities of items. If the database 604 was set up to be exclusively read-only, this would prohibit both the ordering functionality as well as the administrative functionality of the application.

Although the innovation is described with reference to separate and distinct physical machines, it is to be understood that each environment can be configured using a virtual or partially virtual environment. These virtual and/or partially virtual environments are to be included within the scope of this disclosure and claims appended hereto.

It is to be appreciated that if the machines are kept separate, there is an advantage from a scalability standpoint. For example, when a system is scaled up, it is usually scaled linearly, such that if a machine can support Xclients, an ASP would only need to an extra machine for every Xnumber of clients.

However, if traffic is segmented, there is most often more browsing traffic than ordering traffic and administrative traffic. Thus, in accordance with the described functionality, when scaling up, an ASP can scale based upon capacity necessary to handle a particular segment of traffic. Similarly, a machine with greater processing power can be added to scale up. It will be understood and appreciated that adding a more powerful machine benefits all clients rather than just the limited number of clients for which the machine was added as in conventional systems.

The subject disclosure describes a particularly large benefit that can be realized by the service provider in terms of scalability. Thus, justification can be made to invest in additional machines as it will benefit all clients. Further, because traffic can be segmented, it will be appreciated that traffic can be easily diverted to external sources for processing. For example, oftentimes a service provider will employ a third party to process orders. Thus, the innovation described within this specification can be employed to enhance the ability to outsource traffic without affecting traffic within the ASP's cluster of servers.

As described above, another benefit of segmenting traffic as described herein can be realized from a security standpoint. Because traffic is separate, a global security policy can be applied to each type on the back-end (e.g., via connector) to the database 604 since each type of traffic shares read and/or write access as applicable. For instance, none of the browsing traffic will need to have write access therefore, a global policy can be applied to this traffic without affecting ordering and/or administrative traffic. Accordingly, even if vulnerabilities exist in one or more of the websites hosted in this environment, the back-end global security policy will not allow modification of the database from a browsing channel thereby securing the database without blocking legitimate traffic.

With continued reference to FIG. 6, the virtual security front-end 502 can apply a set of security policies 504 to incoming traffic. In the example ASP model, conventionally, different customers usually have different sets of policies 504 which employ multiple machines. It will be understood that this conventional ASP model does not scale as the number of customers increases. Contrary to the conventional model where all traffic is handled the same, the systems and methods described herein disclose a single security gateway (e.g., virtual front-end 502) that is able to segregate different policies in accordance with traffic type, content, customer type, customer identity, etc.

In an example, this gateway 502 can identify which customer's policy 504 to apply based on transport layer criteria (e.g., TCP port, VLAN, NAC or 802.1x information). Further, the gateway 502 can dynamically select a policy set 504 that is similar to the set of all policies that would have been configured on a separate gateway. By way of example, the policy 504 might require that “all purchase orders must be signed.”

Still further, this policy 504 can be specialized by the type of incoming traffic. For example, the policy 504 might be “all purchase orders coming from hosts without NAC (network admission control) must be signed”. In addition to applying the specified policy 504, a tag (such as MPLS (multiprotocol label switching)) can be added to the outbound “cleaned” traffic to identify the type of traffic.

As described above, browsing traffic, transaction traffic, and administrative traffic could be assigned different tags to enable the system to distinguish between the types of traffic. In addition, the ASP may have a contracted SLA (service level agreement) with a client whereas such performance-critical traffic (e.g., such as purchase transactions) may be segmented per client while browsing traffic might not.

Essentially, the virtual security front-end 502 can identify the message type and embed the message type identification tag in the application message for its use by the virtual security back-end network component 602. In operation, the virtual security back-end component 602 can employ the pre-applied identification tags and insert the message type information in the transport or application protocol headers, such as TCP (transmission control protocol), HTTP (hypertext transport protocol), JMS (Java-brand messaging service), or any other suitable protocol. Furthermore, this message type information can be augmented by the information from the policy 504 applied by the front-end component 502.

Turning now to a discussion of the virtual security back-end component 602, the outbound “cleaned” traffic can be sent to a switch which establishes MPLS VPNs (virtual private networks) for each tag. As a result, browsing traffic could be sent to a high-end web farm maintained by the ASP and shared by all. This web farm can be easily scaled up as necessary. Similarly, transaction traffic could be sent to each client's transaction processing agent (1 to Q transaction managers, where Q is an integer). Since each of the transaction managers can be on separate VPNs (or physical machines) they do not impact each other. Administrative traffic would be on yet another VPN (or physical machine) so that, for example, credit card numbers related to the transactions and other confidential/sensitive traffic could not be sniffed by administrators.

As illustrated in FIG. 6, each of these three roles (e.g., browsing, ordering, administration) maps to a specific database access policy on the back-end. Browsing operations will only have access to a database connector that is read-only. Transaction operations will only have access to a single-record read/write connector (e.g., SQL cursor operations disabled).

Still further, administrative operations can be configured for full read/write access, while security policies 504 can be designed to be quite restrictive in granting this access at the front-end 502. As well, credit card numbers and other sensitive data can be encrypted within the database 604. Since sniffing is disabled by the segmented domains, they would be secure even from insiders.

In other aspects, the virtual security back-end component 602 can identify additional security policies 504 to be applied by parsing HTTP, JMS, TCP or any other protocol or transport headers. It will be appreciated that, in conventional systems, such intelligent devices that process application messages, such as AON (application-oriented networking), identify the message type before deciding which policies 504 to invoke. With this approach, the virtual security back-end 602 can leverage the pre-computed message type definition and thus more efficiently applies business and/or security policies 504.

The system 600 illustrated in FIG. 6 can leverage the tagging of messages both at the network level and the message level. This tagging enables application of message security and business capability domain sensitive security policies 504. While the tagging could be accomplished with other mechanisms such as SAML (security assertions markup language), it is to be understood that the use of MPLS allows non-AON network devices to assist in the segmentation of traffic.

The virtual security front-end 502 allows the use of customer-specific security policies 504 that are based on both the incoming message data and the desired service. This allows different policies 504 to be executed based on the source of the data as well as the target service desired (e.g. browsing, ordering, application). For example, a policy could be established that intranet traffic authenticated with NAC or 802.1x will be allowed full access, but extranet traffic would be restricted from using certain services. Furthermore, Internet traffic could be denied unless a cookie is set by a special login web page, and even then the file transfer sizes could be restricted. It is to be understood that most any policy criteria can be employed to trigger security-based privileges.

The virtual security back-end 602 can allow the aggregation of services based upon the security role played by the traffic. As described, this security role can be tagged by the front-end 502. In accordance with the aforementioned specific example, certain traffic (from all customers) can be tagged as “browsing” traffic. Accordingly, this traffic can be aggregated on one VLAN or server so that back-end 602 scalability improvements can benefit all customers within this browsing environment.

Secondly, the back-end 602 can scale appropriately in accordance with the traffic requirements. For example, if there is an increase in one client's web traffic, the system 600 can segment off this specific traffic so as to alleviate effects upon processing requirements on machines serving other clients. Further, another benefit of system 600 is that the database connector on this VLAN can be set up as read-only so that no program bug of any kind could allow a “browser” to modify the database 604.

Other traffic can be tagged as “client #Xtransaction” traffic and can be segmented per-client so that no customer impacts any other client's business. This database connector in the transaction environment could be set up to allow only single-record read/write access. Thus, any bugs that may threaten general database corruption would be filtered and not allowed.

Finally, in the storefront example, some traffic could be administrative, and only such traffic would be granted full access to the database. As well, because the system 600 can employ a separate network for administrative traffic, credit card numbers (and other sensitive data) cannot be sniffed. This could prevent malicious and/or inadvertent “mass credit card #disclosure” issues.

Furthermore, in accordance with the system 600, it may not be necessary to check for spurious security policy violations at the upstream security gateways. In other words, it may not be necessary to search for SQL injection or to scan for virus in application message attachments since such security checks can already be applied at the downstream security gateway (e.g., virtual front-end 502). Consequently, the end-to-end efficiencies and scalability can be achieved by leveraging the distributed infrastructure more effectively.

The subject innovation can employ offloaded dynamic policies 504. For instance, a policy can be applied after login, which allows access for X minutes, without recoding the application. Further, the innovation can keep critical client traffic separate while allowing general traffic to be aggregated. In other words, the system 600 can differentiate traffic types and group traffic based upon a designated or desired type. Access policies can be differentiated based upon a combination of network-level and service-level policy (e.g., intranet can access the order statistics service if NAC or 802.1x authentication is effected, extranet can access purchase orders only with signature, Internet can use system only with login). It is to be appreciated that the subject system, it is not all-or-nothing as traditional NAC, for example, failure to have NAC might just require a user to login like an Internet user, rather than putting them in a sandbox as in accordance with conventional systems.

Although the storefront example described herein address three distinct domains or types of traffic, e.g., browsing, transactional and administrative, it is to be understood that the system 600 can provide for administration of the database 604 on a service-by-service basis. By way of particular example, the system can prohibit access of the administrator of price quotes into the space of transactions. This distinct separation of environments enhances an ASP or hosting entity to secure data between functional domains.

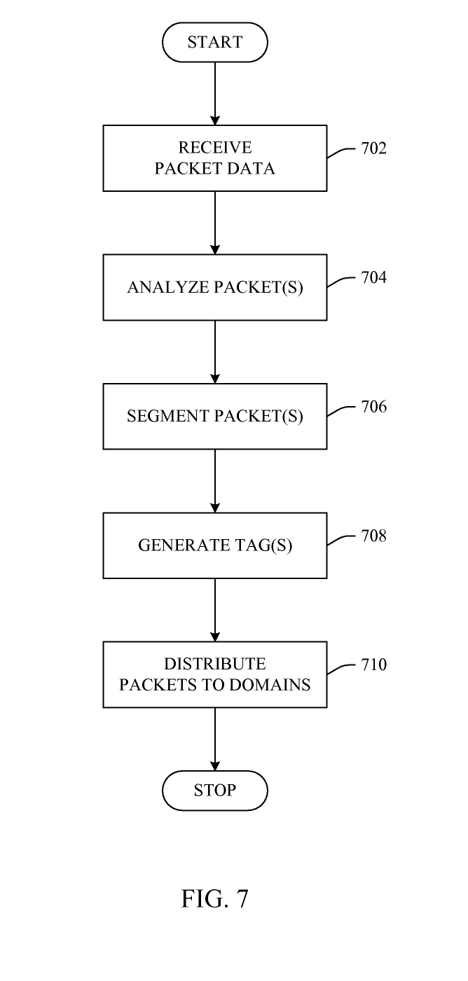

FIG. 7 illustrates a methodology of directing traffic to a specific domain or group of domains in accordance with an aspect of the innovation. While, for purposes of simplicity of explanation, the one or more methodologies shown herein, e.g. in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 702, packet data is received which can represent traffic associated with any number of customer services. For example, the packet data can represent browsing traffic (e.g. catalog browsing in the storefront example above), transaction traffic (e.g., product order traffic in the storefront example above) or administrator traffic. Effectively, the traffic can be any type of traffic associated with a customer service and/or application.

The received packets can be analyzed at 704 and segmented at 706. For example, the traffic can be analyzed in order to effect segmenting the browsing traffic, transactional traffic and administrative traffic from each other. Although the examples described herein are directed to three distinct types of traffic, it is to be understood that the functionality described and claimed herein can be applied to other and/or additional types of traffic without departing from the spirit and/or scope of this disclosure and claims appended hereto.

Once the traffic is segmented, identifying information (e.g., metadata) can be applied to the traffic which identifies characteristics that describe the traffic (e.g., type of traffic, sender's identity, purpose, security policy). In one example, this identifying information can be applied at 708 through the use of tags. It is to be understood that most any technique of marking traffic can be used.

In operation, this identifying information can be used in the distribution of the packets to specific domains at 710. Essentially, this traffic can be directed or redirected to specific domains based upon the characteristics determined at 704.

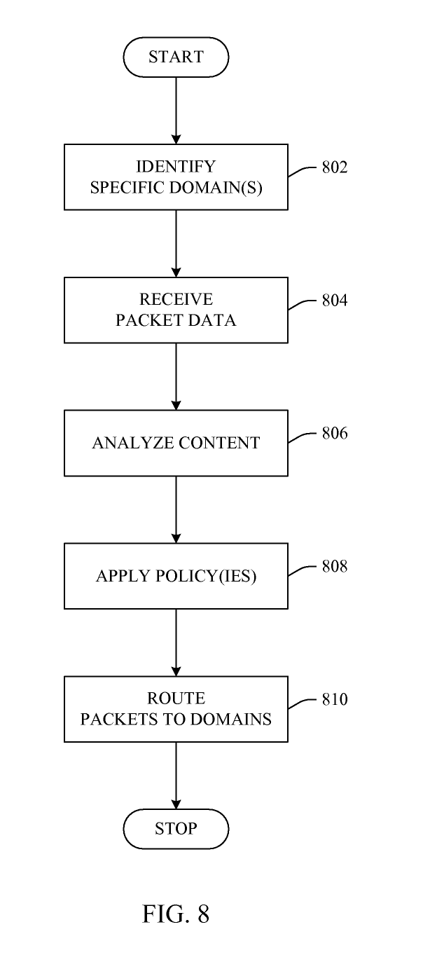

Referring now to FIG. 8, there is illustrated a methodology of directing traffic to specific domains and applying domain-specific security mechanisms in accordance with the innovation. At 802, specific domains can be identified, for example, domains that correspond to a customer, group of customers or ASP as a whole. Regardless of the scope of the domains, these domains can be automatically identified for use in distribution of data traffic.

While the identified domains can be physically distributed, in other aspects, all or a subset of the domains can coexist on a server or group of servers in a ‘virtual’ environment. For instance, in accordance with the Internet storefront described above, suppose a forth domain is identified to represent individual profile updates. In this example, it could be possible for the individual profile update domain to co-exist with the ordering domain as each of them can have limited read/write privileges with respect to the database.

In order to effectively regulate security in each domain, intelligent security policies can be applied on the back-end (e.g., via connector) to ensure proper handling and access to the database. While these intelligent security policies may address security concerns, it is to be appreciated that physical separation of domains lends to efficient scalability for the ASP and/or client.

At 804, packet data is received and analyzed at 806 in order to determine type, purpose, customer, client, etc. All of this information can be employed in order to determine a target domain (or group of domains) for the traffic. More particularly, at 808, policies can be applied to determine where/if packets should be sent. Again, these policies can be rule-based policies as well as policies that employ some degree of machine learning and reasoning (MLR). Ultimately, at 810, packets can be routed to specific domains as appropriate (e.g., based upon classification).

With regard to MLR, the subject system (e.g., in connection with security policy determination and target domain identification) can employ various MLR-based schemes for carrying out various aspects thereof. For example, a process for determining when traffic should be forwarded and, if so, where to forward can be facilitated via an automatic classifier system and process. Moreover, where the domains are located in separate physical locations or if certain traffic is to be forwarded to a third party for processing, the classifier can be employed to determine which location or third party for which to send the traffic while maintaining security.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from this specification, the subject innovation can employ classifiers that are explicitly trained (e.g., via a generic training data) as well as implicitly trained (e.g. via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria how/if to segregate domains, when/where to direct traffic, which policy(ies) to apply to traffic, etc.

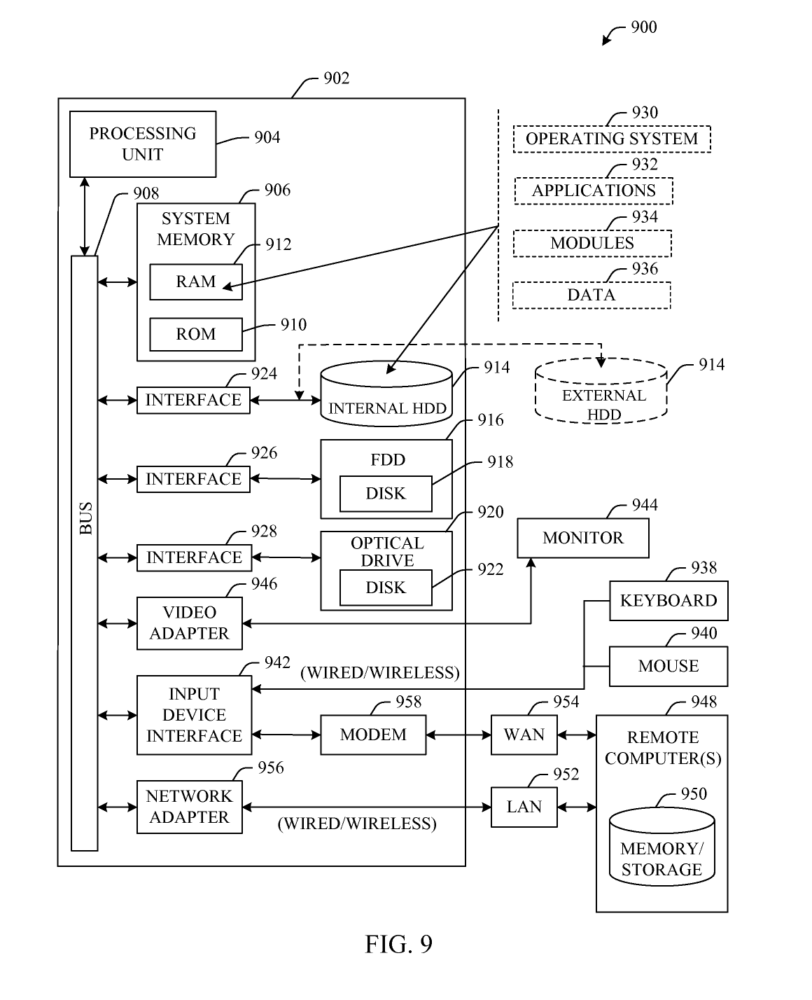

Referring now to FIG. 9, there is illustrated a block diagram of a computer operable to execute the disclosed architecture. In order to provide additional context for various aspects of the subject innovation, FIG. 9 and the following discussion are intended to provide a brief, general description of a suitable computing environment 900 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the innovation includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g. EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the innovation can be implemented with various commercially available operating systems or combinations of operating systems.

A user can enter commands and information into the computer 902 through one or more wired/wireless input devices, e.g. a keyboard 93 8 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

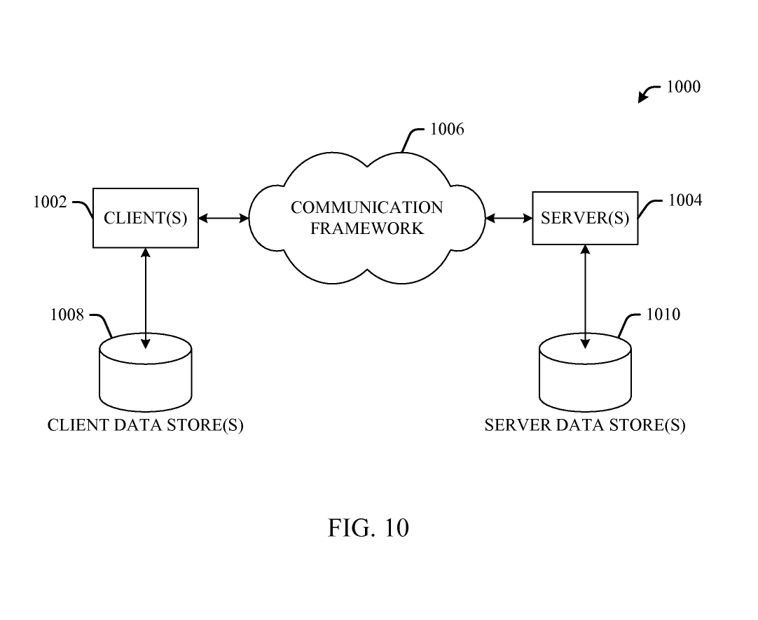

Referring now to FIG. 10, there is illustrated a schematic block diagram of an exemplary computing environment 1000 in accordance with the subject innovation. The system 1000 includes one or more client(s) 1002. The client(s) 1002 can be hardware and/or software (e.g. threads, processes, computing devices). The client(s) 1002 can house cookie(s) and/or associated contextual information by employing the innovation, for example.

The system 1000 also includes one or more server(s) 1004. The server(s) 1004 can also be hardware and/or software (e.g., threads, processes, computing devices). The servers 1004 can house threads to perform transformations by employing the innovation, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates management of traffic to a plurality of domains, comprising:
a traffic segmenting component that separates and tags the traffic as a function of the plurality of domains; and
a traffic routing component that routes the segmented traffic to a subset of the domains as a function of the tags.

2. The system of claim 1, wherein the traffic routing component delivers the traffic to each of the subset of the domains as a function of traffic type.

3. The system of claim 1, the traffic routing component employs a security policy to route the traffic, wherein the security policy defines an access right as a function of traffic type.

4. The system of claim 1, further comprising a content analyzer component that performs deep packet inspection, examines content of the traffic and determines a type associated with the traffic, the traffic segmenting component employs the type to separate and tag the traffic.

5. The system of claim 1, further comprising a type analyzer component that categorizes the traffic as a function of type, the traffic routing component employs the type to deliver the traffic to each of the subset of domains.

6. The system of claim 1, further comprising a packet tagging component that embeds the tags to the traffic for delivery to the subset of the domains.

7. The system of claim 6, further comprising a distribution component that employs the tags and delivers the traffic one of the subset of domains.

8. The system of claim 7, the distribution component employs the tag to associate a security policy that regulates access to a database that is shared by the subset of domains.

9. The system of claim 1, the traffic is received from at least one of an extranet virtual local area network (VLAN), an internet application program interface (API) and an intranet VLAN.

10. The system of claim 1, further comprising a database connector that applies a policy to regulate access to data.

11. The system of claim 1, wherein each of the plurality of domains is located within a specified physical environment as a function of the type.

12. The system of claim 1, wherein each of the plurality of domains is located within a specified virtual environment.

13. A networking component that hosts a plurality of domains, comprising:
a virtual front-end that receives, segregates and delivers customer service traffic to a subset of the plurality of domains as a function of a plurality of tags; and
a virtual back-end that employs a subset of the plurality of tags and regulates access to a database that is shared by the subset of the plurality of domains.

14. The networking system of claim 13, wherein the virtual front-end identifies a policy that corresponds to the segregated customer service traffic and tags the customer service traffic with metadata that corresponds to the policy.

15. The networking system of claim, 14, wherein the virtual back-end regulates access to the database as a function of the policy.

16. The system of claim 15, the plurality of domains includes at least one of a web farm, a transaction manager and an administration service.

17. A method of managing distribution of traffic, comprising:
identifying a plurality of domains associated with a service;
physically segmenting each of the domains;
separating traffic that corresponds to the service as a function of the segmented domains; and
delivering the corresponding traffic to each of the segmented domains.

18. The method of claim 17, further comprising applying a security policy to the segmented traffic as a function of the corresponding domain.

19. The method of claim 18, further comprising tagging the segmented traffic with metadata that corresponds to the security policy.

20. The method of claim 19, further comprising employing the tag to regulate access to a database that is shared by each of the segmented domains.
